(19) United States
(12) Patent Application Publication
(10) Pub. No.: US 2016/0107671 A1
(43) Pub. Date: Apr. 21, 2016

(54) HAND CART BRAKING SYSTEM

(71) Applicants: Gene Wyse, Wauseon, OH (US); Randy Gene Wyse, Wauseon, OH (US)

(72) Inventors: Gene Wyse, Wauseon, OH (US); Randy Gene Wyse, Wauseon, OH (US)

(21) Appl. No.: 14/885,259

(22) Filed: Oct. 16, 2015

Related U.S. Application Data
(60) Provisional application No. 62/065,402, filed on Oct. 17, 2014.

(51) Int. Cl. B62B 5/04; B62B 1/10; B60T 7/10; F16D 49/16; B60T 1/04

(52) U.S. Cl. CPC B62B 5/0485; F16D 49/16; B60T 1/04; B60T 7/102; B62B 1/10; B62B 5/0447

(57) ABSTRACT

An improved braking system for a hand cart is disclosed. The braking system is designed to be hand operated and to provide a simple mechanical stopping system for the cart. The system is lightweight and can be done at a lower cost than conventional braking systems and can prevent binding of the tires into the brakes.

### BACKGROUND OF THE INVENTION

1. Field of the Invention

The present invention relates to a hand operated braking system for a hand cart. More particularly, the present invention includes a hand cart braking system with a simple mechanical braking system, particularly for a cart for use in the commercial delivery business, more particularly for use with refrigerated food delivery vehicles.

2. Summary of Related Art

Hand carts are well known in the material handling industry for loading and unloading material from trucks and trailers. Hands carts are used not only at truck loading docks, but also at retail establishments and other delivery points. Hand carts are also essential devices for moving loads within warehouses and production facilities. The primary construction of a hand cart includes two wheels on a single axle, two vertical frame members with cross frame members, a handle at the top of the frame, and a load engaging flange plate at the bottom of the frame. A typical braking system for a hand cart is a hand operated system positioned on the handle at the top of the frame.

A significant problem which occurs during use of a hand cart is controlling a loaded hand cart on an inclined surface. Inclined surfaces are encountered quite frequently in many hand cart applications, such as maneuvering hand carts up and down truck unloading ramps. The inability to control a loaded hand cart on an inclined surface frequently results in damage to the load being moved and injury to the person operating the hand cart.

When using a hand cart, the operator will frequently use only one hand to control the cart and the other hand is used to engage and steady the load being carried on the cart. Since the operator utilizes one hand on the load, the braking systems on hand carts are generally positioned at the handle and designed for one hand operation.

One of the problems with braking systems on hand carts is that the braking force should be applied uniformly to the two wheels. When the braking force is applied unevenly, the hand cart will not roll in a straight path and will swing to one side. When an operator is applying the brake while rolling a loaded hand cart down a loading ramp, uniform braking to facilitate straight path operation is essential.

Another requirement for hand cart operation is maneuverability. Since hand carts must be operable on a non-linear path when moving a load, it is essential that the braking system not adversely effect the maneuverability of the hand cart. Independent operation of the wheels is required to permit the hand cart to turn corners in a controlled manner.

A majority of hand carts do not have any braking capabilities and the person using the hand cart must use their own strength to stop and/or control a cart on an inclined surface. Several braking systems for hand carts are disclosed in the prior art. The hand carts of the prior art typically include independent wheels and a fixed axle which are mounted on a bracket or other mounting means on the lower corners of the frame. A separate braking mechanism is required for each of the wheels.

In the prior art, Honeyman (U.S. Pat. No. 3,276,550) discloses an U-shaped brake rod mounted between the two wheels. Projecting ends are positioned above the wheels to form a braking means. When the handle is pulled, the projecting ends are positioned in front of the wheels such that a braking force is applied to limit the rotation of the wheels. The forward movement of the wheels tends to cause greater engagement between the wheels and the projecting ends which creates a self actuating feature.

In attempting to improve the maneuverability of the hand cart during braking, Malloy (U.S. Pat. No. 3,486,587) discloses the benefits of having independent operation of the brakes with a single operating handle. A special linkage is attached to the brake shoes of the wheels to provide independent braking.

Wetzel (U.S. Pat. No. 3,368,974) discloses wheels mounted by separate bearings mounted on a fixed axle to provide for independent rotation. A hydraulic system is used to actuate a caliper-type disc brake system mounted at each of the wheels. Equal braking force is applied to each of the wheels. Boyd (U.S. Pat. No. 4,142,732) teaches a disc braking system to brake the main axle shown in the specialized hand cart. The wheels are independently mounted on star-shaped plates, and the plates rotate when the cart is used on stairs. The hand brake system locks the main axle to prevent the plates from rotating.

Laird (U.S. Pat. No. 4,819,767) discloses a braking system which can be used on both two-wheel and four-wheel hand carts. Brake discs are mounted in the frame and are selectively extended from the frame to engage the sidewalls of the wheels to prevent rotation of the wheels.

A hand cart having a brake drum mounted about the hub of the wheels is disclosed in Hedrick (U.S. Pat. No. 5,390,943). The wheels operate independently. The brakes are operated by a single handle with two separate brake actuating cables to two independent brakes. The stopping force to each wheel is equalized by a brake adjusting screw on each brake.

Hlebakos (U.S. Pat. No. 5,433,464) shows a braking system having wheels with a braking shoe and backing plate assembly. A pulley system and cam followers are used to provide equal braking pressure to each of the wheels. Such a braking system is intended for retrofitting on existing hand carts.

The braking system disclosed in Grieg (U.S. Pat. No. 5,524,731) teaches a brake bar mounted on the cart and extending between the two wheels of the cart. Brake pads are mounted on the brake bar which engage the wheels. A step plate is attached to the bar to permit the operator to tilt the hand cart into an operating position.

Wyse (U.S. Pat. No. 5,722,515) discloses a hand cart braking system having a rotatable split axle mounted laterally between the wheels of the hand cart. The axle is split in the middle of the axle to form two distinct segments. Each axle segment rotates with its respective wheel, and the axle segment and wheel on one side of the cart rotate independently of the other axle segment and wheel combination. A brake is mounted on the axle at the junction of the two axle segments. An actuator handle is mounted on the cart at a convenient point for actuating the brake. When the brake is manually operated, the braking force is applied to both segments of the axle to smoothly stop the hand cart. The brake is preferably a disc brake or a drum brake, although other braking devices may also be used in the present system. The brake utilizes a double clutch system to engage and disengage the brake.

### SUMMARY OF THE INVENTION

According to the present invention, there is provided an improved braking system utilizing a simple, lighter weight mechanical assembly.

Instead of utilizing a clutch assembly, the system utilizes a triggering system which activates mechanical stops which engage the wheels of the cart. Stops are mounted in a position relative to the wheels, and are designed to engage with the wheels when activated by the operator. The stops are designed so that they are positioned towards the rear of the wheels, opposite their direction of forward motion, to allow engagement with the wheels with less chance of “binding” the wheels into the brakes.

An object of the present invention is to provide a hand cart braking system that provides a lighter weight, lower costs system than other current braking systems. Many of the braking systems are very complex such that the costs would be unreasonable and too expensive to gain wide spread acceptance in the industry. The present invention is a mechanically simplified system that performs at a high level, yet is mechanically simpler, and thus more cost effective than known braking systems. Additionally, the brake elements of the current system are designed so that it is less likely that the wheels “bind” into the brakes.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings.

FIG. 1 shows a view of a cart with an embodiment of the present invention;

FIG. 2 show a rear cut-away view of the cart of FIG. 1;

FIG. 3 shows an embodiment of a braking mechanism in association with the present invention; and

FIG. 4 shows an alternate embodiment of the braking mechanism in conjunction with the present invention.

### DESCRIPTION OF THE PREFERRED EMBODIMENT

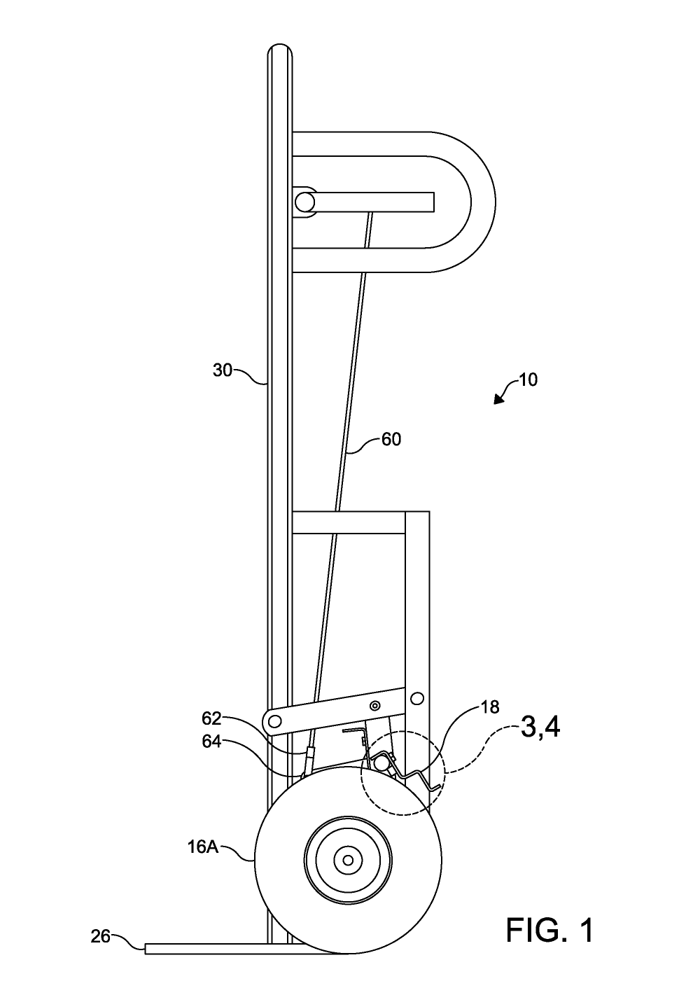

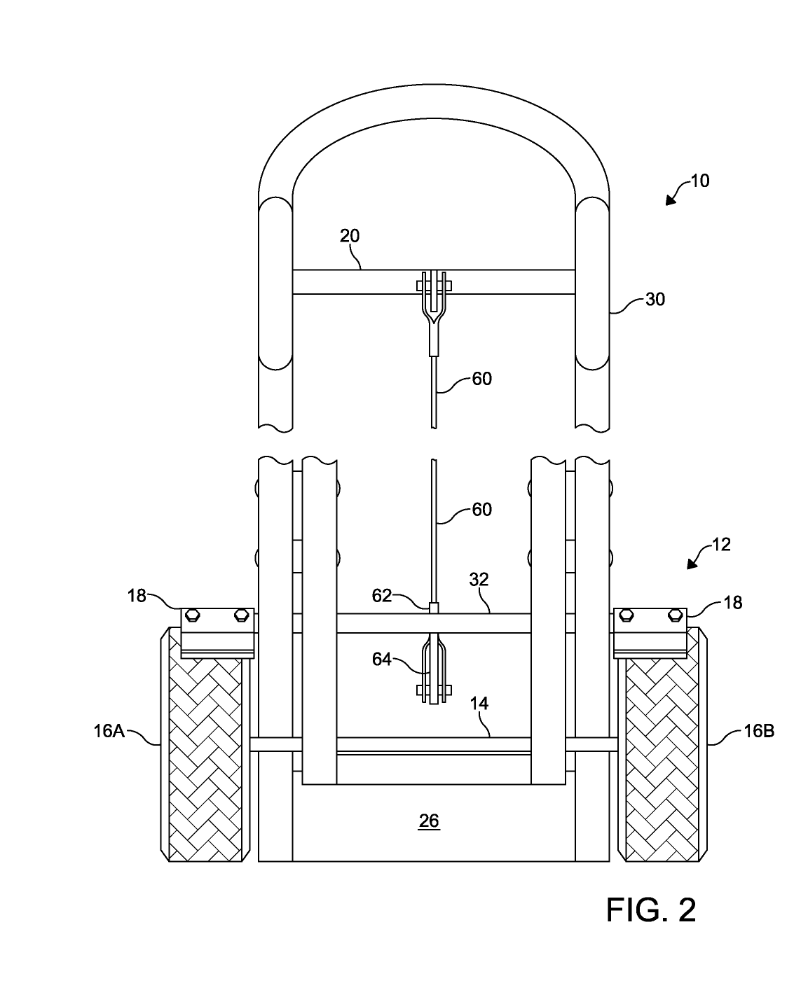

In FIGS. 1 and 2, a hand cart 10, which is suitable for use with the present invention is formed by two elongated, parallel load supporting frame members 30 with struts or cross members 20 and optionally a center strut lengthwise on the cart. Various embodiments of carts are suitable for use with the present invention. Similarly, various handle configurations are known in the industry to facilitate operation of the hand cart 10. The frame members 30 and cross members 20 are typically made from steel or aluminum tubing or bars. The cart 10 includes a braking system 12 connected at one end to a strut or cross member 20. An actuator bar 60 with a handle of any known configuration is used to activate the brake system 12.

At the front, lower end of the frame members, a lifting blade 26 is mounted to extend perpendicularly from the frame members. The lifting blade 26 accomplishes the dual function of lifting and supporting objects to be moved by the hand cart and of maintaining the hand cart in an upright position when not in use.

Wheels 16A, 16B can be connected to the cart 10 as is standard in the art. The wheels 16A, 16B may be furnished with any type of tire, and are preferably connected to one another by a simple axle 14. Brakes are typically furnished on hand carts used for heavier loads, and such hand carts generally include pneumatic or solid rubber tires, although other types of tires are suitable for use in the present invention.

The brake includes a braking axle 32. Although other known systems can be used to connect the individual braking elements, a simple axle is economical and efficient. The actuator 60 can be connected to the braking axle 32 through standard connectors, including linkages or welding. In FIG. 2, the actuator 60 is connected through a connecting linkage 62 to a cross piece 64 which is operably connected to the braking axle 32. At each end of the braking axle 32 are braking elements 18. The braking action may be provided by any type of mechanical, hydraulic, or electrical brake.

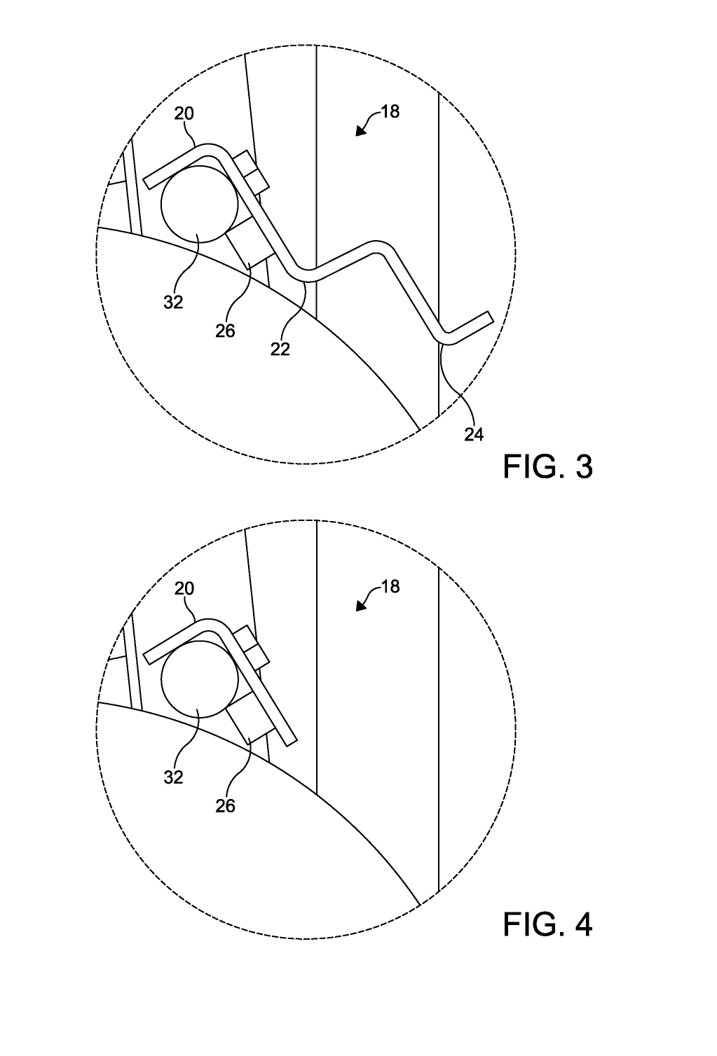

As shown in FIGS. 3 and 4, each braking element 18 is aligned in such a manner as to engage the wheel from the rear relative to the normal direction of forward motion of the hand cart. The braking element 18 includes a first portion 20, which is designed to engage with the braking axle 32. This portion provides a connection to the braking axle 32 so as to allow the user to engage the braking mechanism. This portion 20 is designed at an angle, preferably about 90 degrees, to engage with the braking axle 32. A second portion 22 is formed at another angle, also preferably about 90 degrees. This portion is designed to engage with the tires 16A, 16B, to apply a braking force to the cart, upon activating the braking mechanism. A third angled portion 24 can also be included as part of the braking mechanism. This portion can introduce a second point of contact with the wheel depending on the force applied. An additional stop 26 can be connected to the braking element 18 to allow additional contact and resistance to the wheels.

FIG. 4 shows an alternate embodiment of the braking element. In this embodiment, the first angled portion 20 engages the braking axle 32 as was shown in the previous embodiment. In this embodiment, the additional stop 26 provides contact and resistance to the wheel upon activation of the brake. This braking piece 26 can be integral with the element 18, or can be a separate piece which is attached to the element. The braking element can be connected to the axle in numerous ways, although a mechanical connection such as a bolt is preferred. The element can also be welded to the axle 321.

The operator of the hand cart will often use one hand to secure a load on the load bearing member and use the other hand to control movement of the hand cart. When operating the hand cart with one hand, the hand will usually be positioned near the center of the handle at the top of the cart. A pull handle actuator can be configured near the center of the handle so that the operator can activate the brake system by pulling on the handle with the hand on the cart. The pull handle can be of any configuration known in the art. An extended bar handle, such as the safety handles used on power lawn mowers, would provide a convenient system for one-handed operation of the hand cart and brake system. The pull handle does not have to be positioned near the center of the handle and can arranged in any position on the handle most convenient for the operator.

The invention is not limited to the embodiments shown herein. While aluminum and steel are preferred construction material for the carts, other materials may be suitable for use with embodiments of the present invention.

The braking system of the present invention can be supplied as an original equipment item on new hand carts. In addition, the brake system can be sold as kits for retrofitting on existing carts.

U.S. Pat. No. 5,722,515 discloses embodiments of carts and systems for connecting braking systems to carts that may be suitable for use with the present invention. U.S. Pat. No. 5,722,515 is hereby incorporated by reference as if set forth in its entirety herein.

The configuration of the braking system shown herein has several advantages over known systems. A minimal number of components allows for weight and cost advantages over known braking systems. Also, the configuration of the braking elements allows them to engage the tires in a direction “trailing” or opposite the direction of travel of the cart. A problem with known braking systems is that the tire can be “pulled into” or bind in the braking element. The shown configurations help prevent this pulling and binding of the brakes, increasing the ease of use and also the potential life of the tires.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A hand cart having a frame and a pair of laterally spaced wheels, and a brake assembly, said brake assembly comprising:
an actuator to actuate the braking system;
a strut, the strut being operatively connected to the actuator,
a pair of braking elements, each of said braking elements being configured to engage with one of said pair of laterally spaced wheels; wherein
the braking elements are configured to engage with the wheel in a trailing position relative to the direction of motion of the cart to apply braking force to the cart.

2. The hand cart according to claim 1, wherein the braking element comprises a braking axle connected to a pair of engaging pieces to engage the wheels.

3. The hand cart according to claim 2, wherein each engaging piece further comprises an additional stop connected to the braking axle.

4. The hand cart according to claim 3, wherein each engaging piece comprises a metal piece including 2 approximately 90 degree angles.

5. The hand cart according to claim 1, wherein the brake element comprises a braking axle, a frame structure at each end of the braking axle, and a stop affixed to each of the frame structures.

6. The hand cart according to claim 5, wherein each frame structure is configured such that it does not contact the wheels.

7. The hand cart according to claim 6 wherein each frame structure is bolted to the braking axle.

8. The hand cart according to claim 6 wherein each frame structure is welded to the braking axle.
